(19) United States
(12) Patent Application Publication
(10) Pub. No.: US 2012/0208589 A1
(43) Pub. Date: Aug. 16, 2012

(54) MOBILE COMMUNICATION SYSTEM, RADIO BASE STATION, AND MOBILE STATION

(75) Inventors: Kohei Kiyoshima, Kawasaki-shi (JP); Naoto Okubo, Yokosuka-shi (JP); Hiroyuki Ishii, Yokohama-shi (JP); Seigo Harano, Yokohama-shi (JP)

(73) Assignee: NTT DOCOMO, INC., Tokyo (JP)

(21) Appl. No.: 13/394,821

(22) PCT Filed: Sep. 13, 2010
(86) PCT No.: PCT/JP2010/065723

§ 371 Date: May 2, 2012

(30) Foreign Application Priority Data
Sep. 14, 2009 (JP) 2009-212002

(51) Int. Cl. H04W 52/14; H04W 74/08; H04W 24/02

(52) U.S. Cl. 455/522

(57) ABSTRACT

A radio base station eNB according to the present invention includes: a path loss calculation unit 25 configured to calculate a path loss PL in PUSCH based on a maximum transmittable power PTXMAX, UPH, the number of resource blocks MPUSCH, an offset value ΔTF (TF(i)) corresponding to a transmission format, and a transmission power determination parameter P0_nominal_PUSCH common to cells, and a transmission unit 23 configured to transmit a transmission power offset value P0_UE_PUSCH unique to a mobile station UE, by an RRC message, to the mobile station UE, when a random access procedure is completed, wherein when the random access procedure is completed, the transmission unit 23 transmits a transmission power offset value P0_UE_PUSCH unique to the mobile station, which has a value different from the previously transmitted transmission power offset value P0_UE_PUSCH unique to the mobile station.

### TECHNICAL FIELD

The present invention relates to a mobile communication system, a radio base station, and a mobile station.

### BACKGROUND ART

In an LTE (Long Term Evolution) mobile communication system, a mobile station UE is configured to calculate a path loss in a downlink channel based on a downlink reference signal (DL-RS), and perform “Open-loop TPC (Transmission Power Control)” for controlling transmission power in an uplink channel based on the calculated path loss.

In order to adjust an error of the “Open-loop TPC”, the mobile station UE is configured to perform “Closed-loop TPC” for controlling the transmission power in the uplink channel based on a transmission power control command (a TPC command) received from a radio base station eNB.

Furthermore, in the LTE mobile communication system, in order to perform a scheduling process (for example, determination and the like of a priority or an uplink/downlink transmission bandwidth (resource blocks) assigned to the mobile station UE) with respect to the mobile station UE or to determine a target SIR, it is necessary for the radio base station eNB to accurately recognize a path loss in the uplink channel.

A method for calculating the path loss in the uplink channel includes a method A in which the radio base station eNB calculates the path loss in the uplink channel based on transmission power of the mobile station UE in the uplink channel and received power in the uplink channel, and a method B in which the radio base station eNB calculates the path loss in the uplink channel based on information on the difference between maximum transmittable power received from the mobile station UE and actual transmission power, and a transmission power determination parameter.

In the case of the method B, it is possible to recognize the path loss accurately calculated by the mobile station UE, regardless of the reception accuracy of the uplink channel. The above-mentioned transmission power determination parameter includes a transmission power determination parameter common to cells, and a transmission power determination parameter (a transmission power offset value unique to the mobile station UE, the number of resource blocks assigned to the mobile station UE, an offset value corresponding to a transmission format assigned to the mobile station UE, or an accumulation value of a TPC command) of each mobile station UE.

When non-coincidence occurs between a transmission power determination parameter of the mobile station UE in the radio base station eNB and a transmission power determination parameter actually held by the mobile station UE, the error may be a measurement error of a path loss. Therefore, it is necessary to allow transmission power determination parameters to accurately coincide with each other between the radio base station eNB and the mobile station eNB. However, after a random access procedure, it is not possible for the radio base station UE to recognize a transmission power determination parameter of each mobile station UE, specifically, an accumulation value of a TPC command.

### SUMMARY OF THE INVENTION

Therefore, the present invention has been achieved in view of the above-described problems, and an object thereof is to provide a mobile communication system capable of accurately calculating a path loss in an uplink channel by allowing an accumulation value of a TPC command held by a radio base station eNB to coincide with an accumulation value of a TPC command held by a mobile station UE after a random access procedure, a radio base station, and a mobile station.

A first characteristic of the present invention is summarized as a mobile communication system, in which communication is performed between a radio base station and a mobile station via an uplink channel, in which the radio base station comprises, a path loss calculation unit configured to calculate a path loss in the uplink channel based on maximum transmittable power in the mobile station, information on a difference between the maximum transmittable power received from the mobile station and actual transmission power, the number of resource blocks assigned to the mobile station, an offset value corresponding to a transmission format assigned to the mobile station, and a transmission power determination parameter common to cells, and a transmission unit configured to transmit a transmission power offset value, which is unique to the mobile station, to the mobile station through an individual message when a random access procedure has been completed, the mobile station comprises: a determination unit configured to determine transmission power in the uplink channel based on the number of resource blocks assigned to the mobile station, the offset value corresponding to the transmission format assigned to the mobile station, the transmission power determination parameter common to cells and the transmission power offset value unique to the mobile station, which have been received from the radio base station, a path loss in a downlink channel between the radio base station and the mobile station, and an accumulation value of a transmission power control command received from the radio base station, in which when the random access procedure has been completed, the transmission unit of the radio base station is configured to transmit a transmission power offset value unique to the mobile station, which has a value different from a previously transmitted transmission power offset value unique to the mobile station, and the determination unit of the mobile station is configured to reset the accumulation value of the transmission power control command to “0” when the transmission power offset value unique to the mobile station, which has a value different from a previously received transmission power offset value unique to the mobile station, has been received.

A second characteristic of the present invention is summarized as a radio base station, which is configured to communicate with a mobile station via an uplink channel, comprising, a path loss calculation unit configured to calculate a path loss in the uplink channel based on maximum transmittable power in the mobile station, information on a difference between the maximum transmittable power received from the mobile station and actual transmission power, the number of resource blocks assigned to the mobile station, an offset value corresponding to a transmission format assigned to the mobile station, and a transmission power determination parameter common to cells, and a transmission unit configured to transmit a transmission power offset value, which is unique to the mobile station, to the mobile station through an individual message when a random access procedure has been completed, in which when the random access procedure has been completed, the transmission unit is configured to transmit a transmission power offset value unique to the mobile station, which has a value different from a previously transmitted transmission power offset value unique to the mobile station, thereby resetting an accumulation value of a transmission power control command in the mobile station to “0”.

A third characteristic of the present invention is summarized as a mobile station, which is configured to communicate with a radio base station via an uplink channel, comprising, a determination unit configured to determine transmission power in the uplink channel based on the number of resource blocks assigned to the mobile station, an offset value corresponding to a transmission format assigned to the mobile station, a transmission power determination parameter common to cells and a transmission power offset value unique to the mobile station, which have been received from the radio base station, a path loss in a downlink channel between the radio base station and the mobile station, and an accumulation value of a transmission power control command received from the radio base station, in which the determination unit is configured to reset the accumulation value of the transmission power control command to “0” when a transmission power offset value unique to the mobile station, which has a value different from a transmission power offset value unique to the mobile station and received at a time of completion of a previous random access procedure, has been received.

### BRIEF DESCRIPTION OF THE DRAWINGS

FIG. 1 is a diagram showing the entire configuration of a mobile communication system according to a first embodiment of the present invention.

FIG. 2 is a functional block diagram of a mobile station according to the first embodiment of the present invention.

FIG. 3 is a diagram showing an example of a calculation method of an accumulation value of a TPC command by the mobile station according to the first embodiment of the present invention.

FIG. 4 is a diagram showing an example of a calculation method of transmission power in PUSCH by the mobile station according to the first embodiment of the present invention.

FIG. 5 is a functional block diagram of a radio base station according to the first embodiment of the present invention.

FIG. 6 is a diagram showing an example of a calculation method of a path loss by the radio base station according to the first embodiment of the present invention.

FIG. 7 is a sequence diagram showing an operation of the mobile communication system according to the first embodiment of the present invention.

### DETAILED DESCRIPTION

(Mobile Communication System According to First Embodiment of the Present Invention)

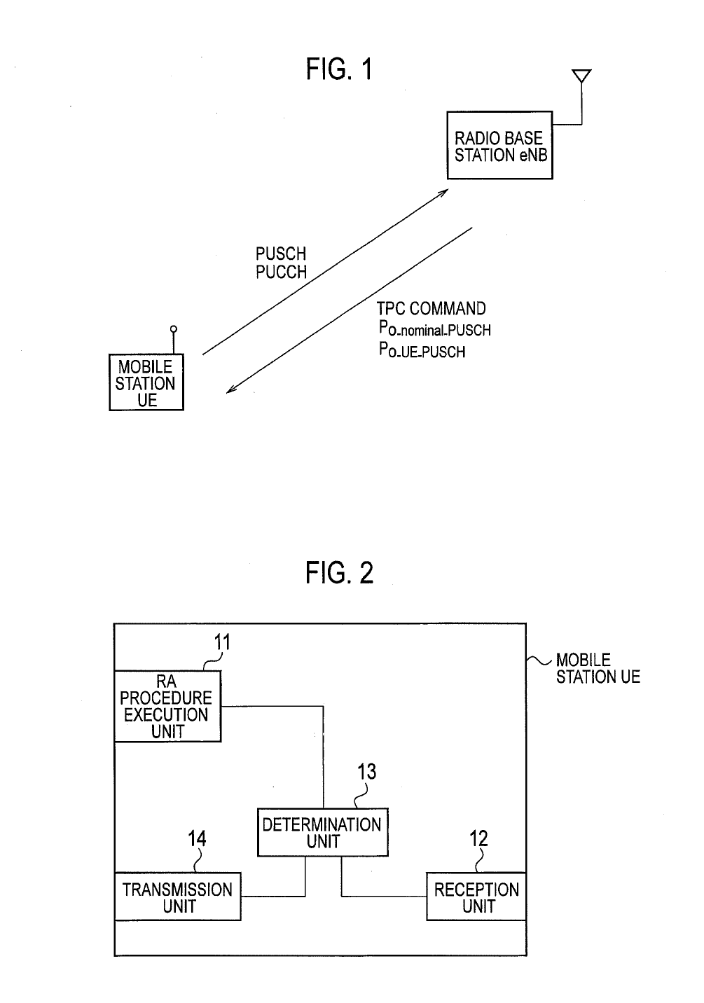

With reference to FIG. 1 to FIG. 6, a mobile communication system according to a first embodiment of the present invention will be described.

As illustrated in FIG. 1, the mobile communication system according to the present embodiment is an LTE mobile communication system. In the mobile communication system according to the present embodiment, a mobile station UE is configured to transmit an uplink data signal to a radio base station eNB via PUSCH (Physical Uplink Shared Channel) which is an uplink channel, and transmit an uplink control signal to the radio base station eNB via PUCCH (Physical Uplink Control Channel) which is an uplink channel.

Furthermore, in the mobile communication system according to the present embodiment, the radio base station eNB is configured to transmit a TPC command, a transmission power determination parameter P_{O}_{_{—}}ₙₒₘᵢₙₐₗ_{_{—}}_{PUSCH} common to cells, or a transmission power offset value P_{O}_{_{—}}_{UE}_{_{—}}_{PUSCH} unique to the mobile station UE, to the mobile station UE via a downlink channel.

As illustrated in FIG. 2, the mobile station UE includes an RA procedure execution unit 11, a reception unit 12, a determination unit 13, and a transmission unit 14.

When communication based on call origination/call terminal is established, when a handover is performed, or when an uplink signal to be transmitted is generated when uplink synchronization has not been achieved between the radio base station eNB and the mobile station UE, the RA procedure execution unit 11 is configured to perform a random access procedure with respect to the radio base station eNB.

In the random access procedure, the RA procedure execution unit 11 is configured to increase transmission power of an RA preamble little by little and retransmit the RA preamble until an RA response is received from the radio base station eNB.

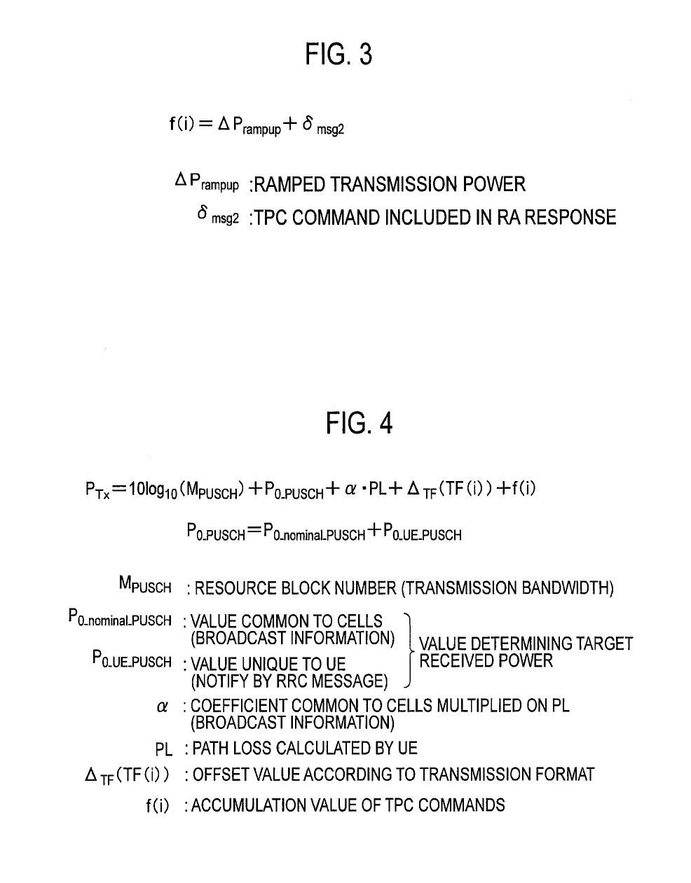

Here, when the random access procedure has been completed, the RA procedure execution unit 11 is configured to reset a variable f(i) according to an equation illustrated in FIG. 3.

The reception unit 12 is configured to receive a downlink signal transmitted by the radio base station eNB via a downlink channel, specifically, a downlink data signal transmitted via PDSCH (Physical Downlink Shared Channel), or a downlink control signal transmitted via PDCCH (Physical Downlink Control Channel).

For example, the reception unit 12 is configured to receive the TPC command, the transmission power determination parameter P_{O}_{_{—}}ₙₒₘᵢₙₐₗ_{_{—}}_{PUSCH} common to cells, and the transmission power offset value P_{O}_{_{—}}_{UE}_{_{—}}_{PUSCH} unique to the mobile station UE, which have been transmitted by the radio base station eNB via the downlink channel.

Here, when the random access procedure has been completed, the reception unit 12 is configured to receive the transmission power offset value P_{O}_{_{—}}_{UE}_{_{—}}_{PUSCH} unique to the mobile station from the radio base station eNB via an RRC message.

The determination unit 13 is configured to determine transmission power P_{TX} in the PUSCH based on the number M_{PUSCH} of resource blocks assigned to the mobile station UE, an offset value ΔTF(TF(i)) corresponding to a transmission format assigned to the mobile station UE, the transmission power determination parameter P_{O}_{_{—}}ₙₒₘᵢₙₐₗ_{_{—}}_{PUSCH} common to cells and the transmission power offset value P_{O}_{_{—}}_{UE}_{_{—}}_{PUSCH} unique to the mobile station UE, which have been received from the radio base station eNB, a path loss PL in a downlink channel between the radio base station eNB and the mobile station UE, a coefficient α common to cells and multiplied to the path loss, and the variable f(i).

Here, the variable f(i) is an accumulation value of the TPC command received from the radio base station eNB. For example, when a TPC command “+1” is received from the radio base station eNB, the determination unit 13 may be configured to increment the variable f(i) by “1”. When a TPC command “−1” is received from the radio base station eNB, the determination unit 13 may be configured to decrement the variable f(i) by “1”.

Specifically, the determination unit 13 is configured to determine the transmission power P_{TX} in the PUSCH according to an equation illustrated in FIG. 4.

Here, when the reception unit 12 has received a transmission power offset value P_{O}_{_{—}}_{UE}_{_{—}}_{PUSCH} unique to the mobile station UE, which has a value different from the previously received transmission power offset value P_{O}_{_{—}}_{UE}_{_{—}}_{PUSCH} unique to the mobile station UE, the determination unit 13 is configured to reset the variable f(i) to “0”.

The transmission unit 14 is configured to transmit an uplink data signal to the radio base station eNB via the PUSCH, and transmit an uplink control signal to the radio base station eNB via the PUCCH.

For example, the transmission unit 14 is configured to regularly transmit “UPH (UE Power Headroom)” to the radio base station eNB. Here, the UPH indicates information on the difference between maximum transmittable power P^{TX}_{MAX} in the mobile station UE and actual transmission power P_{TX} in the PUSCH in the mobile station UE.

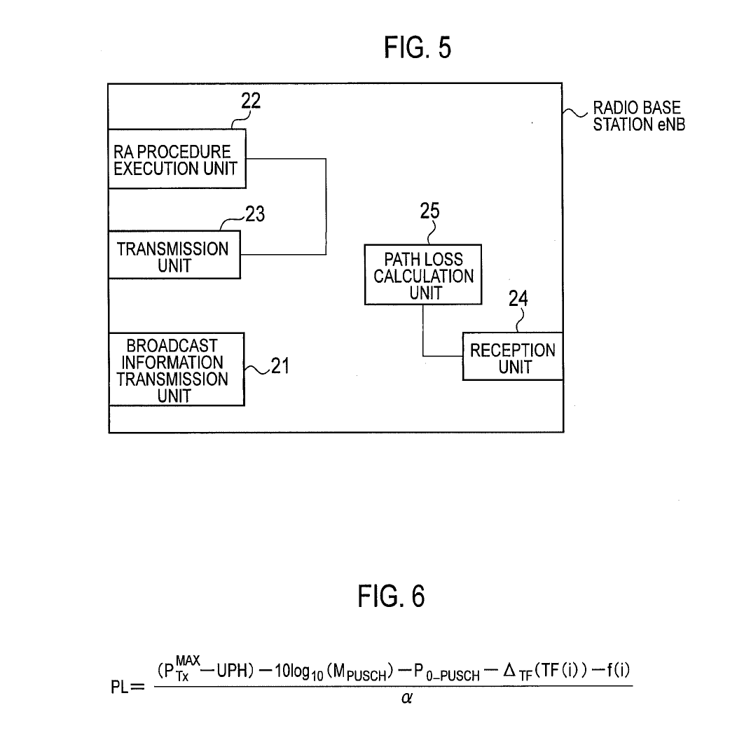

As illustrated in FIG. 5, the radio base station eNB includes a broadcast information transmission unit 21, an RA procedure execution unit 22, a transmission unit 23, a reception unit 24, and a path loss calculation unit 25.

The broadcast information transmission unit 21 is configured to transmit broadcast information (for example, MIB (Master Information Block), SIB (System Information Block) and the like) in a subordinate cell of the radio base station eNB.

For example, the broadcast information transmission unit 21 is configured to transmit the above-mentioned transmission power determination parameter P_{O}_{_{—}}ₙₒₘᵢₙₐₗ_{_{—}}_{PUSCH} common to cells, the coefficient α common to cells and multiplied to the path loss, and the like as the broadcast information.

When communication based on call origination/call terminal is established, when a handover is performed, or when an uplink signal to be transmitted is generated when uplink synchronization has not been achieved between the radio base station eNB and the mobile station UE, the RA procedure execution unit 22 is configured to perform the random access procedure with respect to the mobile station UE.

The transmission unit 23 is configured to transmit a downlink data signal to the mobile station UE via the PDSCH, and transmit a downlink control signal to the mobile station UE via the PDCCH.

Specifically, the transmission unit 23 is configured to transmit an RRC message to the mobile station UE being connected to the radio base station eNB.

For example, when the random access procedure has been completed, the transmission unit 23 is configured to transmit the transmission power offset value P_{O}_{_{—}}_{UE}_{_{—}}_{PUSCH} to the mobile station UE through the RRC message, wherein the transmission power offset value P_{O}_{_{—}}_{UE}_{_{—}}_{PUSCH} is unique to the mobile station UE.

Here, when the random access procedure has been completed, the transmission unit 23 is configured to transmit a transmission power offset value P_{O}_{_{—}}_{UE}_{_{—}}_{PUSCH} unique to the mobile station UE, which has a value different from the previously transmitted transmission power offset value P_{O}_{_{—}}_{UE}_{_{—}}_{PUSCH} unique to the mobile station UE.

For example, the transmission unit 23 may be configured to alternately transmit a transmission power offset value P_{O}_{_{—}}_{UE}_{_{—}}_{PUSCH} unique to the mobile station UE, which has been set to “0”, and a transmission power offset value P_{O}_{_{—}}_{UE}_{_{—}}_{PUSCH} unique to the mobile station UE, which has been set to “1”.

Furthermore, the transmission unit 23 is configured to transmit scheduling information (for example, resource information such as the number of resource blocks assigned to the mobile station UE, and the like) to the mobile station UE via the PDCCH.

The reception unit 24 is configured to receive the uplink signal transmitted by the mobile station UE via the uplink channel, specifically, the uplink data signal transmitted via the PUSCH or the uplink control signal transmitted via the PUCCH.

For example, the reception unit 24 is configured to receive the UPH regularly transmitted by the mobile station UE via the uplink channel.

The path loss calculation unit 25 is configured to calculate the path loss PL in the PUSCH based on the maximum transmittable power P^{TX}_{MAX} in the mobile station UE, the information UPH on the difference between the maximum transmittable power received from the mobile station UE and the actual transmission power, the number MPUSCH of resource blocks assigned to the mobile station UE, the offset value Δ_{TF}(TF(i)) corresponding to the transmission format assigned to the mobile station UE, the transmission power determination parameter P_{O}_{_{—}}ₙₒₘᵢₙₐₗ_{_{—}}_{PUSCH} common to cells, and the coefficient α common to cells and multiplied to the path loss.

For example, the path loss calculation unit 25 may be configured to calculate the path loss PL in the PUSCH according to an equation illustrated in FIG. 6.

Here, since a TPC command accumulation value f(i) held by the mobile station UE is reset according to the Equation illustrated in FIG. 3 at the time point at which a random access response is received, it is not possible for the path loss calculation unit 25 to recognize the TPC command accumulation value f(i) at the time point at which the random access procedure has been completed.

Thus, at the time point at which the random access procedure has been completed, the transmission unit 23 is configured to transmit a transmission power offset value P_{O}_{_{—}}_{UE}_{_{—}}_{PUSCH} unique to the mobile station UE, which has a value different from the previously transmitted transmission power offset value P_{O}_{_{—}}_{UE}_{_{—}}_{PUSCH} unique to the mobile station UE, thereby resetting the TPC command accumulation value f(i) held by the mobile station UE to “0”.

Consequently, at the time point at which the random access procedure has been completed, it is possible for the determination unit 23 to set the TPC command accumulation value f(i) in the Equation illustrated in FIG. 6 to “0” and calculate the path loss PL in the PUSCH.

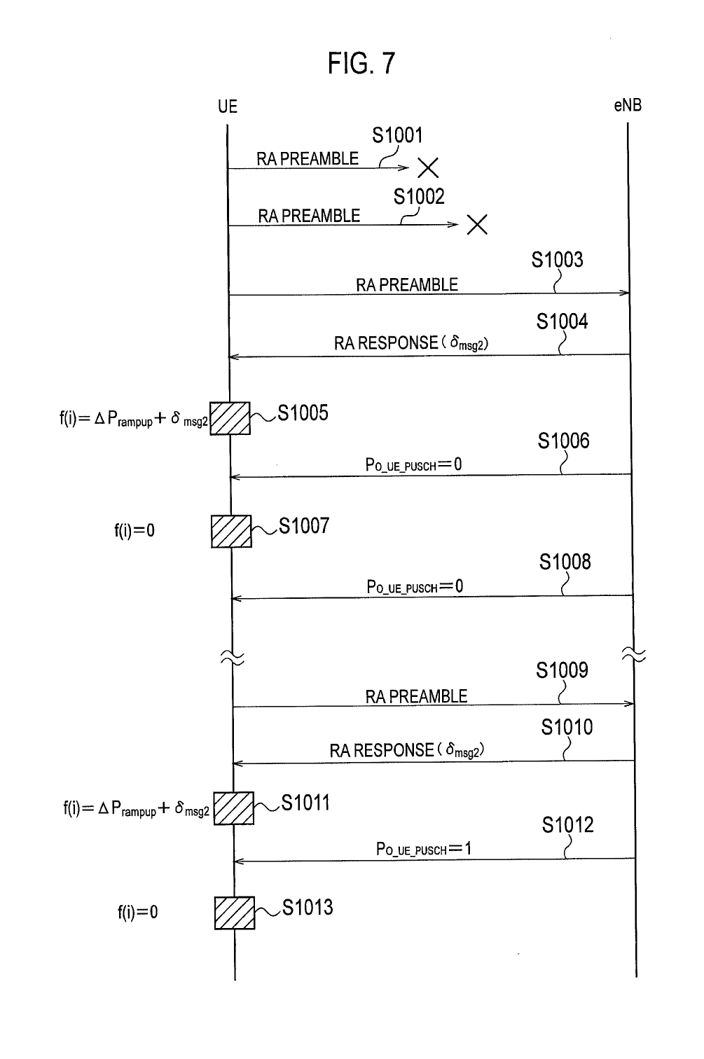

Hereinafter, with reference to FIG. 7, the operation of the mobile communication system according to the present embodiment will be described.

As illustrated in FIG. 7, in step S1001, the mobile station UE transmits an RA preamble with RA preamble initial transmission power to the radio base station eNB. However, the RA preamble does not reach the radio base station eNB. In step S1002, the mobile station UE transmits the RA preamble with transmission power further increased by Δramup,step to the radio base station eNB. However, the RA preamble does not also reach the radio base station eNB.

In addition, the Δramup,step is a step value of power ramping at the time of RA preamble retransmission, and is notified to the mobile station UE from the radio base station eNB as broadcast information.

In step S1003, if the mobile station UE transmits the RA preamble with transmission power further increased by Δramup,step to the radio base station eNB, the RA preamble reaches the radio base station eNB.

In step S1004, the radio base station eNB transmits an RA response including a TA command δmsg2 to the mobile station UE.

In step S1005, the mobile station UE resets the variable f(i) by “f(i)=ΔPramup+δmsg2” when the random access procedure has been completed.

Here, since the ΔPramup is a power ramping sum value and power ramping has been performed twice in steps S1002 and S1003, “ΔPramup=2×Δramup,step” is established.

In step S1006, the radio base station eNB transmits the transmission power offset value P_{O}_{_{—}}_{UE}_{_{—}}_{PUSCH} unique to the mobile station UE, which has been set to “0”, to the mobile station UE.

In step S1007, when the transmission power offset value P_{O}_{_{—}}_{UE}_{_{—}}_{PUSCH} unique to the mobile station UE, which has been set to “0”, has been received, the mobile station UE resets the TPC command accumulation value f(i) to “0”.

Here, it is assumed that the mobile station UE has received the transmission power offset value P_{O}_{_{—}}_{UE}_{_{—}}_{PUSCH} unique to the mobile station UE, which has been previously set to “1”, or has not received the transmission power offset value P_{O}_{_{—}}_{UE}_{_{—}}_{PUSCH} unique to the mobile station UE after starting a connection to the radio base station eNB.

In step S1008, the mobile station UE receives the transmission power offset value P_{O}_{_{—}}_{UE}_{_{—}}_{PUSCH} unique to the mobile station UE, which has been set to “0”, from the radio base station eNB.

Here, it is assumed that the mobile station UE determines that a transmission power offset value P_{O}_{_{—}}_{UE}_{_{—}}_{PUSCH} unique to the mobile station UE, which has the same value as the previously transmitted transmission power offset value P_{O}_{_{—}}_{UE}_{_{—}}_{PUSCH} unique to the mobile station UE, has been received, and does not reset the TPC command accumulation value f(i).

In step S1009, if the mobile station UE transmits the RA preamble with the RA preamble initial transmission power to the radio base station eNB, the RA preamble reaches the radio base station eNB.

In step S1010, the radio base station eNB transmits the RA response including the TA command δmsg2 to the mobile station UE.

In step S1011, the mobile station UE resets the TPC command accumulation value f(i) by “f(i)=ΔPramup+δmsg2” when the random access procedure has been completed. Here, since the power ramping has never been performed, “ΔPramup=0” is established.

In step S1012, the radio base station eNB transmits the transmission power offset value P_{O}_{_{—}}_{UE}_{_{—}}_{PUSCH} unique to the mobile station UE, which has been set to “1”, to the mobile station UE.

In step S1007, when the transmission power offset value P_{O}_{_{—}}_{UE}_{_{—}}_{PUSCH} unique to the mobile station UE, which has been set to “1”, has been received, the mobile station UE determines that a transmission power offset value P_{O}_{_{—}}_{UE}_{_{—}}_{PUSCH} unique to the mobile station UE, which has a value different from the previously transmitted transmission power offset value P_{O}_{_{—}}_{UE}_{_{—}}_{PUSCH} unique to the mobile station UE, has been received, and resets the TPC command accumulation value f(i) to “0”.

In accordance with the mobile communication system according to the present embodiment, even after the random access procedure, it is possible for the radio base station eNB to accurately calculate the path loss in the uplink channel.

Furthermore, in accordance with the mobile communication system according to the present embodiment, when the random access procedure has been completed, it is possible for the radio base station eNB to reset an accumulation value f(i) of a TPC command in the mobile station UE to “0”, thereby avoiding the occurrence of a problem that it is not possible to recognize the accumulation value f(i) of the TPC command in the mobile station UE.

In addition, in the above-mentioned mobile communication system according to the present embodiment, the path loss calculation unit 25 of the radio base station eNB may be configured to calculate a path loss in PUCCH in the same manner as the path loss in the PUSCH.

The characteristics of the present embodiment as described above may also be expressed as follows.

A first characteristic of the present embodiment is summarized in that a mobile communication system, in which communication is performed between a radio base station eNB and a mobile station UE via PUSCH (an uplink channel), wherein the radio base station eNB includes: the path loss calculation unit 25 configured to calculate a path loss PL in the PUSCH based on maximum transmittable power P^{TX}_{MAX} in the mobile station UE, information UPH on the difference between maximum transmittable power received from the mobile station UE and actual transmission power, the number M_{PUSCH} of resource blocks assigned to the mobile station UE, an offset value Δ_{TF}(TF(i)) corresponding to a transmission format assigned to the mobile station UE, and a transmission power determination parameter P_{O}_{_{—}}ₙₒₘᵢₙₐₗ_{_{—}}_{PUSCH} common to cells; and the transmission unit 23 configured to transmit a transmission power offset value P_{O}_{_{—}}_{UE}_{_{—}}_{PUSCH}, which is unique to the mobile station UE, to the mobile station UE through an RRC message (an individual message) when a random access procedure has been completed, wherein the mobile station UE includes: the determination unit 13 configured to determine transmission power P_{TX} in the PUSCH based on the number M_{PUSCH} of resource blocks assigned to the mobile station UE, the offset value Δ_{TF}(TF(i)) corresponding to the transmission format assigned to the mobile station UE, the transmission power determination parameter P_{O}_{_{—}}ₙₒₘᵢₙₐₗ_{_{—}}_{PUSCH} common to cells and the transmission power offset value P_{O}_{_{—}}_{UE}_{_{—}}_{PUSCH} unique to the mobile station UE, which have been received from the radio base station eNB, a path loss PL in a downlink channel between the radio base station eNB and the mobile station UE, and an accumulation value f(i) of a TPC command received from the radio base station eNB, wherein the transmission unit 23 of the radio base station eNB is configured to transmit a transmission power offset value P_{O}_{_{—}}_{UE}_{_{—}}_{PUSCH} unique to the mobile station UE, which has a value different from a previously transmitted transmission power offset value P_{O}_{_{—}}_{UE}_{_{—}}_{PUSCH} unique to the mobile station UE, when the random access procedure has been completed, and the determination unit 13 of the mobile station UE is configured to reset the accumulation value f(i) of the TPC command to “0” when a transmission power offset value P_{O}_{_{—}}_{UE}_{_{—}}_{PUSCH} unique to the mobile station UE, which has a value different from a previously received transmission power offset value P_{O}_{_{—}}_{UE}_{_{—}}_{PUSCH} unique to the mobile station UE, has been received.

In the first characteristic of the present embodiment, the path loss calculation unit 25 of the radio base station eNB may also be configured to calculate the path loss PL in the PUSCH further based on the transmission power offset value P_{O}_{_{—}}_{UE}_{_{—}}_{PUSCH} unique to the mobile station UE.

The second characteristic of the present embodiment is summarized in that a radio base station eNB, which is configured to communicate with a mobile station UE via PUSCH, includes: the path loss calculation unit 25 configured to calculate a path loss PL in the PUSCH based on maximum transmittable power P^{TX}_{MAX} in the mobile station UE, information UPH on the difference between maximum transmittable power received from the mobile station UE and actual transmission power, the number MPUSCH of resource blocks assigned to the mobile station UE, an offset value Δ_{TF}(TF(i)) corresponding to a transmission format assigned to the mobile station UE, and a transmission power determination parameter P_{O}_{_{—}}ₙₒₘᵢₙₐₗ_{_{—}}_{PUSCH} common to cells; and the transmission unit 23 configured to transmit a transmission power offset value P_{O}_{_{—}}_{UE}_{_{—}}_{PUSCH}, which is unique to the mobile station, to the mobile station UE through an RRC message when a random access procedure has been completed, wherein when the random access procedure has been completed, the transmission unit 23 transmits a transmission power offset value P_{O}_{_{—}}_{UE}_{_{—}}_{PUSCH} unique to the mobile station UE, which has a value different from a previously transmitted transmission power offset value P_{O}_{_{—}}_{UE}_{_{—}}_{PUSCH} unique to the mobile station UE, thereby resetting an accumulation value f(i) of a TPC command in the mobile station UE to “0”.

In the second characteristic of the present embodiment, the path loss calculation unit 25 may also be configured to calculate the path loss PL in the PUSCH further based on the transmission power offset value P_{O}_{_{—}}_{UE}_{_{—}}_{PUSCH} unique to the mobile station UE.

The third characteristic of the present embodiment is summarized in that a mobile station UE, which is configured to communicate with a radio base station eNB via PUSCH, includes: the determination unit 13 configured to determine transmission power PTx in the PUSCH based on the number M_{PUSCH} of resource blocks assigned to the mobile station UE, an offset value Δ_{TF}(TF(i)) corresponding to a transmission format assigned to the mobile station UE, a transmission power determination parameter P_{O}_{_{—}}ₙₒₘᵢₙₐₗ_{_{—}}_{PUSCH} common to cells and a transmission power offset value P₀_{_{—}}_{UE}_{_{—}}_{PUSCH} unique to the mobile station UE, which have been received from the radio base station eNB, a path loss PL in a downlink channel between the radio base station eNB and the mobile station UE, and an accumulation value f(i) of a TPC command received from the radio base station eNB, wherein the determination unit 13 is configured to reset a variable f(i) to “0” when a transmission power offset value P₀_{_{—}}_{UE}_{_{—}}_{PUSCH} unique to the mobile station UE, which has a value different from a previously received transmission power offset value P_{O}_{_{—}}_{UE}_{_{—}}_{PUSCH} unique to the mobile station UE, has been received.

It is noted that the operation of the above-described the radio base station eNB or the mobile station UE may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the radio base station eNB or the mobile station UE. Further, such a storage medium or a processor may be arranged, as a discrete component, in the radio base station eNB or the mobile station UE.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

### INDUSTRIAL APPLICABILITY

As described above, according to the present invention, it is possible to provide a mobile communication system capable of accurately calculating a path loss in an uplink channel by allowing an accumulation value of a TPC command held by a radio base station eNB to coincide with an accumulation value of a TPC command held by a mobile station UE after a random access procedure, a radio base station, and a mobile station.

1. A mobile communication system, in which communication is performed between a radio base station and a mobile station via an uplink channel, wherein
the radio base station comprises: a path loss calculation unit configured to calculate a path loss in the uplink channel based on maximum transmittable power in the mobile station, information on a difference between the maximum transmittable power received from the mobile station and actual transmission power, the number of resource blocks assigned to the mobile station, an offset value corresponding to a transmission format assigned to the mobile station, and a transmission power determination parameter common to cells; and
a transmission unit configured to transmit a transmission power offset value, which is unique to the mobile station, to the mobile station through an individual message when a random access procedure has been completed,
the mobile station comprises: a determination unit configured to determine transmission power in the uplink channel based on the number of resource blocks assigned to the mobile station, the offset value corresponding to the transmission format assigned to the mobile station, the transmission power determination parameter common to cells and the transmission power offset value unique to the mobile station, which have been received from the radio base station, a path loss in a downlink channel between the radio base station and the mobile station, and an accumulation value of a transmission power control command received from the radio base station,
wherein when the random access procedure has been completed, the transmission unit of the radio base station is configured to transmit a transmission power offset value unique to the mobile station, which has a value different from a previously transmitted transmission power offset value unique to the mobile station, and
the determination unit of the mobile station is configured to reset the accumulation value of the transmission power control command to “0” when the transmission power offset value unique to the mobile station, which has a value different from a previously received transmission power offset value unique to the mobile station, has been received.

2. The mobile communication system according to claim 1, wherein
the path loss calculation unit of the radio base station is configured to calculate the path loss in the uplink channel further based on the transmission power offset value unique to the mobile station.

3. A radio base station, which is configured to communicate with a mobile station via an uplink channel, comprising:
a path loss calculation unit configured to calculate a path loss in the uplink channel based on maximum transmittable power in the mobile station, information on a difference between the maximum transmittable power received from the mobile station and actual transmission power, the number of resource blocks assigned to the mobile station, an offset value corresponding to a transmission format assigned to the mobile station, and a transmission power determination parameter common to cells; and
a transmission unit configured to transmit a transmission power offset value, which is unique to the mobile station, to the mobile station through an individual message when a random access procedure has been completed,
wherein when the random access procedure has been completed, the transmission unit is configured to transmit a transmission power offset value unique to the mobile station, which has a value different from a previously transmitted transmission power offset value unique to the mobile station, thereby resetting an accumulation value of a transmission power control command in the mobile station to “0”.

4. The radio base station according to claim 3, wherein
the path loss calculation unit is configured to calculate the path loss in the uplink channel further based on the transmission power offset value unique to the mobile station.

5. A mobile station, which is configured to communicate with a radio base station via an uplink channel, comprising: a determination unit configured to determine transmission power in the uplink channel based on the number of resource blocks assigned to the mobile station, an offset value corresponding to a transmission format assigned to the mobile station, a transmission power determination parameter common to cells and a transmission power offset value unique to the mobile station, which have been received from the radio base station, a path loss in a downlink channel between the radio base station and the mobile station, and an accumulation value of a transmission power control command received from the radio base station, wherein
the determination unit is configured to reset the accumulation value of the transmission power control command to “0” when a transmission power offset value unique to the mobile station, which has a value different from a transmission power offset value unique to the mobile station and received at a time of completion of a previous random access procedure, has been received.
